(19) United States
(12) Patent Application Publication
(10) Pub. No.: US 2026/0121343 A1
(43) Pub. Date: Apr. 30, 2026

(54) Metal Insert and Connector

(71) Applicants: Tyco Electronics (Suzhou) Ltd., Suzhou City (CN); Tyco Electronics (Shanghai) Co., Ltd., Shanghai (CN)

(72) Inventors: Jiawei (Jarvis) Gu, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 19/374,088

(22) Filed: Oct. 30, 2025

(30) Foreign Application Priority Data
Oct. 31, 2024 (CN) 202422647719.6

(51) Int. Cl. H01R 13/621; H01R 12/70

(52) U.S. Cl. CPC H01R 13/621; H01R 12/7047

(57) ABSTRACT

Disclosed is a metal insert. The metal insert is applied to a plastic housing of a connector, and an inner hole of the metal insert is not threaded, wherein the metal insert is adapted to be embedded in an opening of the plastic housing of the connector. Disclosed is also a connector, wherein the metal insert is embedded in the opening of the plastic housing of the connector.

### CROSS-REFERENCE TO RELATED APPLICATION

This application claims the benefit of the filing date under 35 U.S.C. § 119 (a)-(d) of Chinese Patent Application No. 202422647719.6, filed on Oct. 31, 2024.

### FIELD OF THE INVENTION

The present invention relates to a technical field of electrical connector accessories and, more particularly, to a metal insert adapted for a connector and a connector.

### BACKGROUND OF THE INVENTION

There are currently several existing structural designs and installation methods for an insert connector on the market.

In the first design, a sealing ring is arranged on a flange face of a plastic housing and positioned between the plastic housing and a board end. A self-tapping screw is adopted to be inserted directly through an opening of the board end and an opening of the plastic housing to secure the connector to the board end. Disadvantages of this design are that there is cracking or stripping of the screw holes due to direct installation of a self-tapping screw into the opening of the plastic housing, resulting in sealing issues and the inability to re-tighten after disassembly. To address the disadvantage in this design, the following second and third designs have emerged on the market.

In the second design, a sealing ring is arranged on the flange face of the plastic housing and positioned between the plastic housing and the board end. An insert is injection-molded in the opening of the plastic housing. A conventional screw is adopted to be inserted directly through the opening of the board end and the insert inside the opening of the plastic housing to secure the connector to the board end. Deficiencies of this design are that: a) it is necessary to machine internal threads in an inner hole of the insert, and the cost of the insert is relatively high; and, b) for these inserts with small threaded holes, it is also needed to consider that the positioning accuracy and smoothness of the inner hole during the molding process of the insert and the plastic housing, and if the hole diameter tolerance is too large, it will lead to unstable positioning accuracy and smoothness.

In the third design, the sealing ring is arranged on a back face of the plastic housing opposite to the flange face. The insert has only a through hole, but no threads. The insert is inserted into the opening of the board and the opening of the plastic housing. Deficiencies of this design are that user needs to pass a conventional screw through the through hole of the insert and tap it into the board end so as to be connected to the board end, which encounters high installation costs.

However, each of the above designs has disadvantages and/or deficiencies that need to be addressed and overcome. Therefore, the industry urgently needs an improved structure design and installation method of the connector.

### SUMMARY OF THE INVENTION

A metal insert includes an inner hole. The inner hole is not threaded. The metal insert is embedded in an opening of a plastic housing of a connector.

### BRIEF DESCRIPTION OF DRAWINGS

The invention will now be described by way of example with reference to the accompanying figures, of which:

FIG. 1 is a perspective view of a connector according to an exemplary embodiment, where a metal insert is assembled into an opening of the connector;

FIG. 2 is a perspective view of the metal insert of FIG. 1;

FIG. 3 is a partial cross-sectional view of the metal insert of FIG. 1 assembled into the opening of the connector of FIG. 1; and

FIG. 4 is a partial cross-sectional view of a metal insert according to another exemplary embodiment, where the metal insert is assembled into the opening of FIG. 1 of the connector of FIG. 1.

### DETAILED DESCRIPTION

The technical solution of the present disclosure is further specifically described below through embodiments and in combination with the accompanying drawings. In the specification, the same or similar reference signs denote the same or similar parts. The following description of embodiments of the present disclosure with reference to the accompanying drawings is intended to explain the general inventive concept of the present disclosure, and should not be construed as limiting the present disclosure.

In addition, in the following detailed descriptions, for ease of explanation, numerous specific details are set forth in order to provide a thorough understanding of embodiments of the present disclosure. However, one or more embodiments may be implemented without these specific details. In other instances, well-known structures and devices are illustrated schematically in order to simplify the drawing.

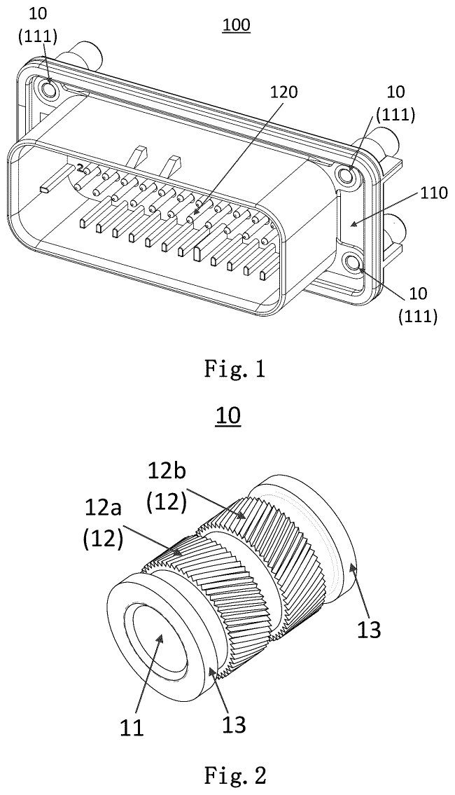

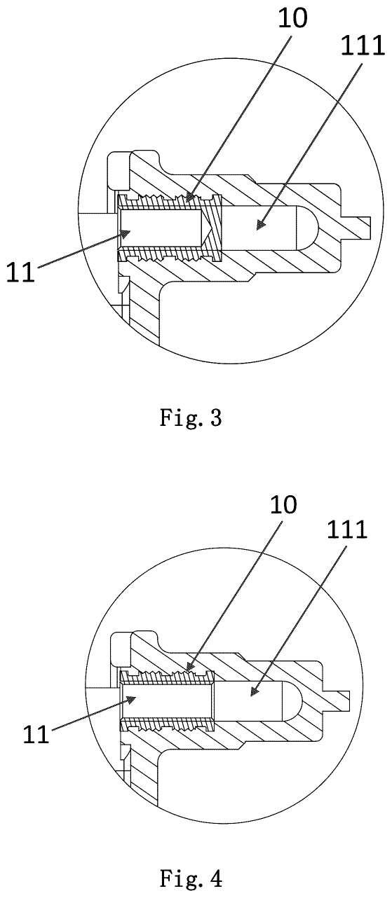

An exemplary embodiment of a metal insert 10 will now be described with reference to FIGS. 1-3. The metal insert 10 can be made of a metal material such as copper or a copper alloy. As shown in FIGS. 1 and 3, the metal insert 10 is applied to a plastic housing 110 of a connector 100. As shown in FIGS. 2-3, an inner hole 11 of the metal insert 10 is not threaded.

As shown in FIGS. 1-2, the metal insert 10 is an independent component and is adapted to be embedded in an opening 111 of the plastic housing 110 of the connector 100. The inner hole 11 of the metal insert 10 is not threaded or formed with threads (internal threads). With this design, the manufacturing and inspection processes for the threads (internal threads) is reduced, which may effectively reduce the production cost of the metal insert 10. Furthermore, the design of the inner hole 11 not being provided or formed with a thread (internal thread) ensures that a size of a diameter of the inner hole 11 is processed more stably, thereby effectively guaranteeing the positional accuracy and smoothness of the metal insert 10 in the plastic housing 110 during the subsequent injection-molding of the plastic housing 110 and the connector 100.

As shown in FIG. 2, the metal insert 10 is an independent component, and its inner hole 11 without thread can be cooperated with a self-tapping screw to be installed, that is, the metal insert 10 is adapted for the installation of the self-tapping screw. Therefore, the metal insert 10 can be reused after removing the screw installed in the inner hole 11. Consequently, as the metal insert 10 is made of metal material, there is no cracking or stripping problem that occurs in inserts made of plastic material; thus, the metal insert 10 being made of a metal material improves the durability and reliability of the overall metal insert 10.

As shown in FIG. 2, an outer peripheral wall of the metal insert 10 is provided with a knurled structure 12. Specifically, the knurled structure 12 includes a first knurled section 12a and a second knurled section 12b. The knurled pattern of the first knurled section 12a is different from that of the second knurled section 12b. Furthermore, as shown in FIG. 2, an end of the metal insert 10 is formed with a flange 13 in a radial direction. More specifically, a height of the knurled structure 12 in the radial direction of the metal insert 10 is substantially flush with a height of the flange 13 in the radial direction of the metal insert 10. With the aforementioned design of the knurled structure 12 and/or flange 13 (i.e., addition of the knurled structures 12a, 12b with different knurled patterns; and/or addition of the flange 13), the firmness when the metal insert 10 is embedded in the plastic housing 110 of the connector 100 can be increased, and the stability and anti-disassembly ability of the overall structure can be enhanced.

As shown in FIG. 3, according to one exemplary embodiment of the present disclosure, the inner hole 11 of the metal insert 10 can be designed as a blind hole.

Another exemplary embodiment of the metal insert 10 will now be described with reference to FIG. 4. The metal insert 10 according to FIG. 4 differs from the metal insert 10 according to FIGS. 1-3 in that the inner hole 11 of the metal insert 10 according to FIG. 4 is a through hole.

An exemplary embodiment of the connector 100 will now be described with reference to FIGS. 1 and 3-4. As shown in FIG. 1, the connector 100 includes the plastic housing 110 and a connection terminal 120 disposed within the plastic housing 110. As shown in FIG. 1, the connector 100 has a plurality of the connection terminals 120. The plastic housing 110 is formed with an opening 111, into which the metal insert 10 according to FIGS. 1-3 or the metal insert 10 according to FIG. 4 is embedded. Reference to both the metal insert 10 according to FIGS. 1-3 or the metal insert 10 according to FIG. 4 will be hereinafter referred to as the “embodiments of the metal insert 10”.

As shown in FIG. 1, each of four corners of the plastic housing 110 is provided with a post, and each post is provided with the opening 111 therein. One of the embodiments of the metal insert 10 is embedded in each opening 111. Preferably, the one of the embodiments of the metal insert 10 can be injection-molded in the opening 111 by an injection-molding process, so that the two can be closely combined, thereby ensuring the precise and stable positioning of the one of the embodiments of the metal insert 10 in the plastic housing 110. More specifically, the opening 111 is designed as a blind hole to achieve a good seal performance when the connector 100 is assembled with a board end.

According to the embodiments of the metal insert 10 and the connector 100, the embodiments of the metal insert 10 adopts the independent design and the design of the inner hole 11 without thread: (1) ensures sealing performance, while effectively reduce the production and installation costs, (2) improves the processing accuracy and durability, (3) allows the embodiments of the metal insert 10 to be reused and not easily damaged after disassembly, and (4) significantly improves the market competitiveness of the product.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, the disclosed embodiments in the accompanying drawings are intended to illustrate embodiments of the present disclosure by way of example, and should not be construed as limitation to the present disclosure.

Although some embodiments of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

1. A metal insert, comprising:
an inner hole that is not threaded, the metal insert is embedded in an opening of a plastic housing of a connector.

2. The metal insert of claim 1, wherein the inner hole is a through hole.

3. The metal insert of claim 1, wherein the inner hole is a blind hole.

4. The metal insert of claim 1, wherein an outer peripheral wall of the metal insert has a knurled structure.

5. The metal insert of claim 4, wherein the knurled structure includes a first knurled section and a second knurled section.

6. The metal insert of claim 5, wherein a knurled pattern of the first knurled section is different from a knurled pattern of the second knurled section.

7. The metal insert of claim 4, wherein an end of the metal insert is formed with a flange in a radial direction.

8. The metal insert of claim 1, wherein the metal insert has a pair of ends, each end of the metal insert is formed with a flange in a radial direction.

9. The metal insert of claim 7, wherein a height of the knurled structure in the radial direction is flush with a height of the flange in the radial direction.

10. The metal insert of claim 1, wherein a self-tapping screw is installed in the inner hole.

11. A connector, comprising:
a plastic housing formed with an opening;
a connection terminal disposed in the plastic housing; and
a metal insert embedded in the opening, the metal insert has an inner hole that is not threaded.

12. The connector of claim 11, wherein the metal insert is molded into the opening by an injection-molding process.

13. The connector of claim 11, wherein the connection terminal is one of a plurality of connection terminals.

14. The connector of claim 11, wherein the plastic housing has a post.

15. The connector of claim 14, wherein the opening is provided in the post.

16. The connector of claim 11, wherein the plastic housing has a plurality of posts and the opening is one of a plurality of openings, each opening is provided in one post.

17. The connector of claim 16, wherein the plastic housing has a plurality of corners, each post is formed on one corner.

18. The connector of claim 11, wherein the opening is a blind hole.

19. The connector of claim 11, further comprising a self-tapping screw is installed in the inner hole.
